(19) United States
(12) Patent Application Publication
(10) Pub. No.: US 2006/0155510 A1
(43) Pub. Date: Jul. 13, 2006

(54) Omnidirectional wireless pedometer

(76) Inventor: Yu-Yu Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,121

(22) Filed: Jan. 11, 2005

(51) Int. Cl. G01C 22/00; G01B 11/02; G01B 11/14

(52) U.S. Cl. 702/160

(57) ABSTRACT

An omnidirectional wireless pedometer includes a transmitter and a receiver. The transmitter includes a vibration sensor, a transmitter control circuit, an oscillating circuit and a transmitting antenna. The vibration sensor detects a vibration signal when a user walks or jogs and transmits the vibration signal to the transmitter control circuit. Then, the vibration signal is transmitted to the oscillating circuit which generates an oscillating signal and forwards the oscillating signal to the transmitting antenna for transmitting out wirelessly. The receiver comprises three receiving antennas respectively arranged in X, Y, and Z directions. The receiving antennas are capable to receive pace signal from different directions and generate a resonance signal. Subsequently, the resonance signal is transmitted to a receiver control circuit for processing, which generates a data signal to be displayed in a displayed unit.

### FIELD OF THE INVENTION

The present invention relates to a wireless motion monitoring device, and more particularly, to a wireless pedometer fitting around a user's waist for receiving pace signal in all directions.

### BACKGROUND OF THE INVENTION

There are a variety of body building devices and exercisers developed for people who live busily in the modern commercial society and require appropriate exercises. For a person to accurately control a moderate amount of exercise and monitor personal physical condition, various types of body/motion signal sensing devices have been researched and developed.

Among the various motion signal sensing devices, pedometer is the most extensively used. Pedometer is generally compact, convenient for taking along and simple for use, which is capable to measure the accumulated number of paces that a user advances at, for example, walking or jogging. There are many kinds of pedometers in the market. Some of the pedometers are able to receive motion signal wirelessly, and some are designed with fastening members for fitting, for example, to the shoe of the user.

The conventional wireless pedometer includes a transmitter which is fitted around the user's waist for detecting the paces the user taken at walking and a receiver which is fitted around the user's wrist for receiving the pace signal. When the user walks or jogs, the transmitter transmits the pace signal wirelessly to the receiver, on which a display unit is arranged for showing the data. Thereby, the user can monitor the accumulated number of paces he advances.

The conventional uniaxial type wireless pedometer includes only a single transmitting antenna disposed in the transmitter and a single receiving antenna disposed in the receiver. Please refer to FIG. 1, which shows that a pace signal in a form electro-magnetic wave is transmitted out from the transmitting antenna of a conventional uniaxial type wireless pedometer. In the design, the pace signal is transmitted out at the two ends of the transmitting antenna 1 and spreads around the transmitting antenna 1, forming the electro-magnetic wave 11. In the most ideal condition, the electro-magnetic wave 11 is received wirelessly by a receiving antenna 2 located within an effective receiving distance.

Practically, when applying the conventional technique, to optimize signal reception, the uniaxial type receiving antenna should be put in a position substantially parallel to the transmitting antenna. However, it is not easy to maintain the relatively parallel positions of the receiving antenna and the transmitting antenna. Inevitably, the receiving antenna receives poor signal, or even no signal.

It is found that poor reception of signal is remarkable especially when the wireless signal transmission technique is applied in dynamic applications. Take for an example. In applying the wireless signal transmission technique to a wireless pedometer, the receiver in a form of wrist watch is fitted to the wrist of the user, and the transmitter is fitted around the waist or a special part of the body of the user. At walking or doing exercise, the hands of the user follow the body motion and swing from one position to another naturally. Accordingly, the position of the receiver relative to the transmitter is changing. Hence, the receiver cannot be maintained in a parallel position relative to the transmitter for optimal signal reception. Hence, the signal cannot be effectively received.

In addition to the aforesaid factor, the strength of the signal received by a wireless receiver depends on both of the distance and the orientation between the transmitter and the receiver. When the receiver is located far from the transmitter, the received signal is very weak, and it is not able to decode and recognize the signal, especial two wireless pedometers walking along.

Furthermore, the width of the signal waveform is varied with the distance between the transmitter and receiver. When the receiver is located at a far distance from the transmitter, the width of the signal waveform becomes very narrow. Similarly, the signal cannot be decoded and is not readable.

To improve the aforesaid drawbacks, in U.S. Pat. No. 4,625,733, a telemetric measuring apparatus is disclosed, which includes three ferrite core elements and three magnetic coils in parallel design. Although the inductive coupling is enhanced by using three ferrite core elements and three magnetic coils, there are the following disadvantages:

(1) The magnetic fields among the ferrite core elements and magnetic coils interfere with and are weakened by each other;

(2) Incurring three times higher power consumption;

(3) Larger space is needed for three transmitting antenna design; and

(4) In practical application, the signal is enhanced in some directions, but the signal is also weakened or interfered in other directions, especial two/the people walking along.

### SUMMARY OF THE INVENTION

Thus, a primary object of the present invention is to provide an omnidirectional wireless pedometer which is capable to receive signal in all directions. It is not necessary to maintain the transmitting antenna in parallel position relative to that of the receiving antenna.

Another object of the present invention is to provide a wireless pedometer comprising three receiving antennas in series design which are respectively arranged in X, Y and Z directions. Thereby, resonance of pace signal can be produced in different directions. Hence, the receiver is able to effectively receive the pace signal transmitted from the transmitter in very low power consumption, even when the position and direction of the receiver is changed.

A further object of the present invention is to provide an omnidirectional wireless pedometer which can prevent the interference from a neighbor pedometer. The signal is encoded and decoded by distinctive and effective techniques.

To achieve the above and other objects, in accordance with the present invention, there is provided with an omnidirectional wireless pedometer which includes a transmitter and a receiver. The transmitter includes a vibration sensor, a transmitter control circuit, an oscillating circuit and a transmitting antenna. The vibration sensor detects a vibration signal when a user walks or jogs and transmits the vibration signal to the transmitter control circuit. Then, the vibration signal is transmitted to the oscillating circuit which generates an oscillating signal and forwards the oscillating signal to the transmitting antenna for transmitting out wirelessly. The receiver comprises three receiving antennas respectively arranged in X, Y, and Z directions in series design. The receiving antennas are capable to receive pace signal from different directions and generate a resonance signal. Subsequently, the resonance signal is transmitted to a receiver control circuit for processing, which generates a data signal to be displayed in a displayed unit.

### BRIEF DESCRIPTION OF THE DRAWINGS

The present invention will be apparent to those skilled in the art by reading the following description of the best mode and a preferred embodiment of a device for carrying out the present invention, with reference to the attached drawings, in which:

FIG. 1 is a schematic view, which shows that a pace signal in a form electro-magnetic wave is transmitted out from a transmitting antenna of a conventional wireless pedometer;

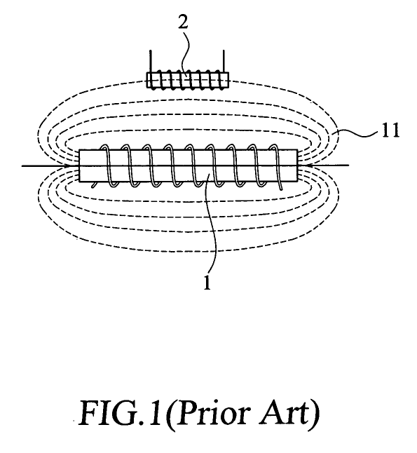

FIGS. 2A to 2C are perspective views showing that an omnidirectional wireless pedometer constructed in accordance with the present invention is fitted to a user;

FIG. 3 is a schematic view showing the arrangement of three receiving antennas in a receiver;

FIG. 4 is a circuit diagram of a transmitter of the omnidirectional wireless pedometer of the present invention;

FIG. 5 is a circuit diagram of a receiver of the omnidirectional wireless pedometer of the present invention; and

FIG. 6 is a chart showing the pace signal is encoded and decoded in accordance with the techniques of the present invention.

### DETAILED DESCRIPTION OF THE PREFERRED EMBODIMENTS

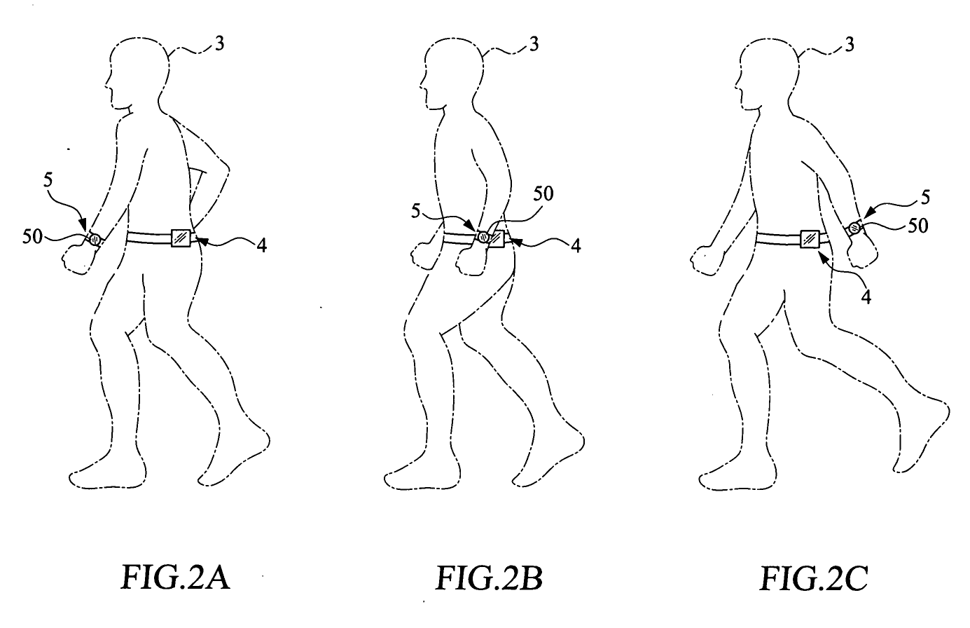

Please refer to the drawings and in particular to FIGS. 2A to 2C which show that an omnidirectional wireless pedometer constructed in accordance with the present invention is fitted to a user who is walking. The omnidirectional wireless pedometer comprises a wireless transmitter 4 and a wireless receiver 5. The wireless transmitter 4 is fitted around the waist of the user 3 or any part of the body, and the wireless receiver 5 is fitted to the wrist of the user 3. A display unit which may comprises a LCD 58 is arranged on the wireless receiver 5 for displaying the pace signal received from the receiver 5.

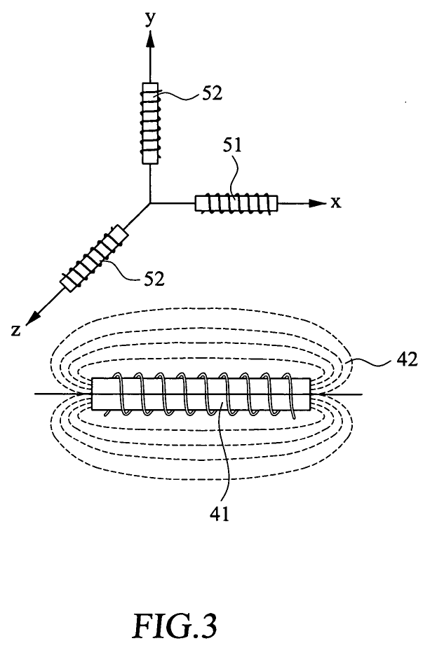

FIG. 3 is a schematic view showing the arrangement of three receiving antennas in the receiver for receiving the magnetic field transmitted by the transmitter. The transmitter 4 comprises a single transmitting antenna 41, while the receiver 5 comprises three series receiving antennas 51, 52, 53 arranged in three different directions.

To optimize signal reception, preferably, the receiver antennas 51, 52, 53 are arranged in X, Y and Z directions, forming a three dimensional omnidirectional signal receiving station.

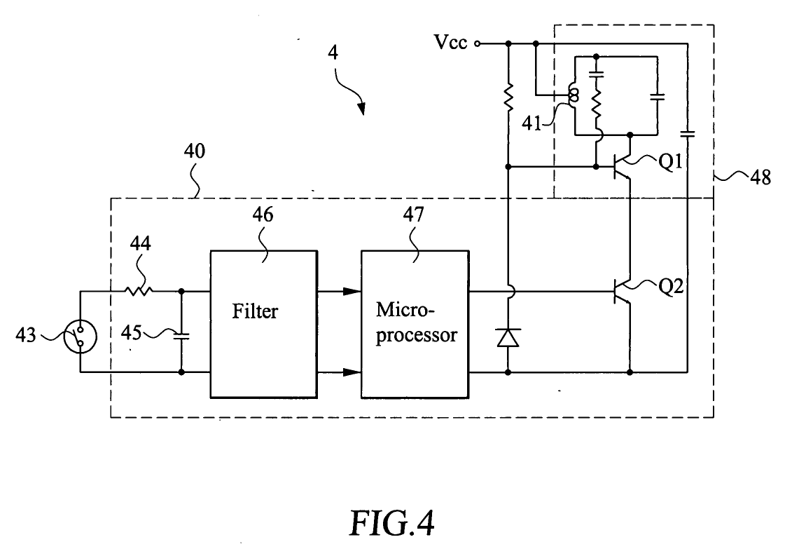

Please refer to FIG. 4, which is a circuit diagram of the transmitter of the omnidirectional wireless pedometer. The transmitter 4 comprises a vibration sensor 43 which detects the vibration signal of the user at walking or jogging. The vibration sensor 43 forwards the vibration signal to a transmitter control circuit 40 for processing.

The transmitter control circuit 40 comprises de-bouncing circuit including a resistor 44 and a capacitor 45, an amplifier and filter 46, microprocessor 47 and a transistor Q2. The vibration signal is transmitted to the de-bouncing circuit and then to the amplifier and filter 46 for amplification and filtering. Subsequently, the vibration signal is transmitted to a microprocessor 47 for encoding. The encoded signal is forwarded to a transistor Q2. Then, the signal is transmitted to an oscillating circuit 48 which comprises a transmitter antenna 41, a transistor Q1, resistors and capacitors. The oscillating circuit 48 generates an oscillating signal which is transmitted out wirelessly by the wireless transmitting antennas.

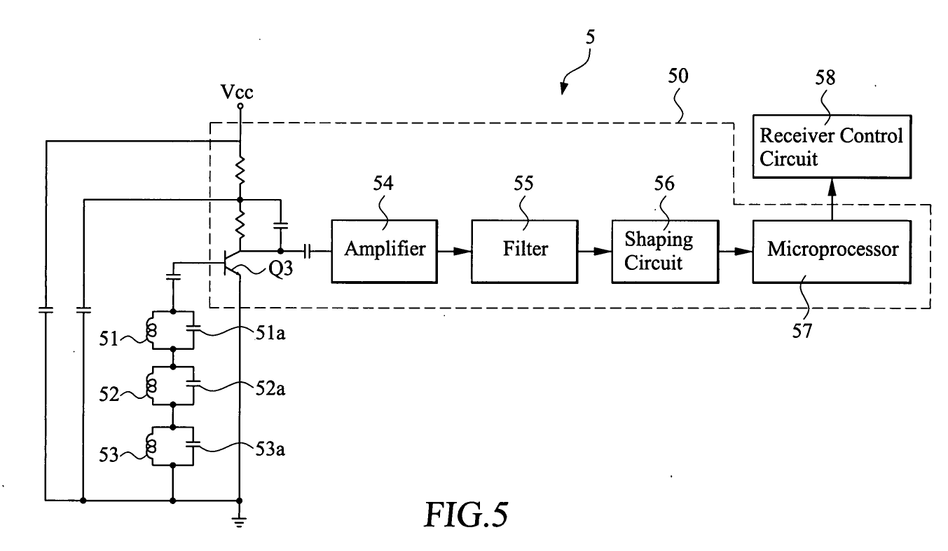

FIG. 5 is a circuit diagram of the wireless receiver of the omnidirectional wireless pedometer. The wireless receiver 5 comprises three wireless series receiving antennas 51, 52, 53 respectively arranged in X, Y and Z directions. Each of the wireless receiving antennas 51, 52, 53 is parallelly coupled with a capacitor 51a, 52a, 53a, forming a resonance circuit. The resonance circuits are able to resonate with magnetic fields transmitted from different directions and generate a resonance signal. The resonance signal is forwarded to a receiver control circuit 50 for processing.

The receiver control circuit 50 comprises transistor Q3, an amplifier 54, a filter 55, a shaping circuit 56 and a microprocessor 57. The resonance signal is transmitted to the transistor Q3 of the receiver control circuit 50. The signal is then forwarded to the amplifier 54 for amplifying, to the filter 55 for filtering and to the shaping circuit 56 for shaping to generate a standard signal of pre-determined level. Finally, the microprocessor 57 decodes the signal, generates a data signal, and transmit the data signal to a display unit 58 for displaying.

When two wireless pedometers are used in neighborhood, the signal transmitted wirelessly from the transmitter of one pedometer may be received by the receiver of the other pedometer. Since the three receiving antennas of the omnidirectional wireless pedometer of the present invention are arranged respectively in the X, Y and Z direction, at least one of the receiving antennas is aligned in parallel with the transmitter of the nearby pedometer and would receives the wireless signal therefrom. Accordingly, interference between nearby pedometers occurs, and incorrect pace signal is received and displayed.

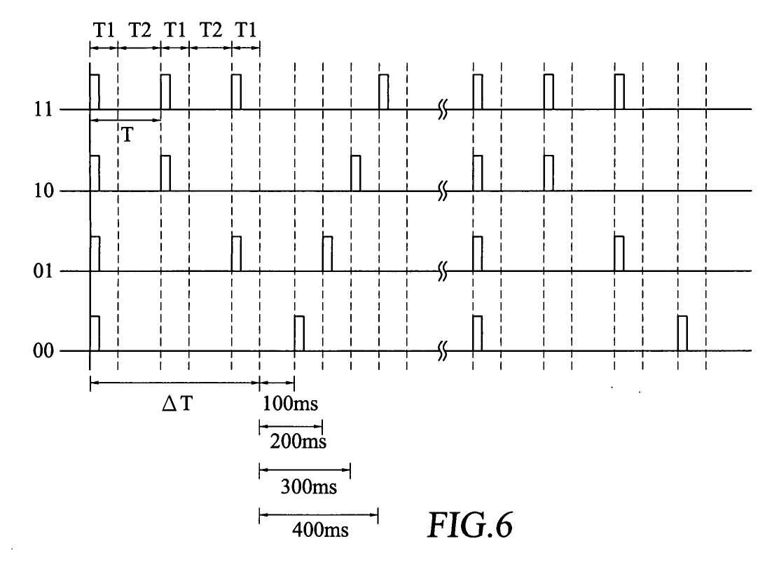

To avoid interference among two or more wireless pedometers used in a close vicinity, the omnidirectional wireless pedometer employs an economic, distinctive and effective encoding and decoding technique. Please refer to FIG. 6 which shows the waveforms of the signals processed by the encoding and decoding technique. The encoding technique for transmitter comprises the following steps:

(1) T represents the time required for the signal to traverse one complete cycle, i.e. the cycle time. One cycle time represents a high level signal “1” or a low level signal “0”. In other words, T=T1+T2, in which T1 is the time of the high level signal and T2 is the time of low level signal;

(2) instead of using address and date code that are conventionally used in known arts, each omnidirectional wireless pedometer is given an ID code for recognition of individual pedometer. Hence the length of the signal is reduced, and interference between two kinds of signals is prevented; for example, in the case when four omnidirectional wireless pedometers are used in a close vicinity:

(a) the first pedometer is given an ID code of 11; each time when the user takes a step, the transmitter transmits three recognition signals in a pre-determined time of ΔT;

(b) the second pedometer is given an ID code of 10; each time when the user takes a step, the transmitter transmits two successive recognition signals in a pre-determined time of ΔT;

(c) the third pedometer is given an ID code of 01; each time when the user takes a step, the transmitter transmits two recognition signals in a pre-determined time of ΔT, in which the two recognition signals are separated by a low level signal;

(d) the fourth pedometer is given an ID code of 00; each time when the user takes a step, the transmitter transmits one recognition signal in a pre-determined time of ΔT;

(3) in accordance with the delay time of the ID code, the transmitting antenna delays the transmission of signal after the pre-determined time ΔT, and thereby the interference among pedometers is avoided; in the example, the delay times of the first, second, third and fourth pedometers are 400 ms, 300 ms, 200 ms and 100 ms respectively.

The decoding technique for the receiver comprises the following steps:

(1) the correctness of the signal is checked by verifying if the cycle time T is equal to T1+T2;

(2) the user identity is recognized from the ID code and the pace speed of the user is calculated; and

(3) the source of the signal is identified from the ID code and predetermined delay time, to assure that the signal received comes from the corresponding transmitter.

Assuming that when two people are walking together and the pace speed of each people is one step per second, and T1=5 ms and T2=5 ms, within the pre-determined time ΔT, the time of the first pedometer (ID code 11) is equal to T1+T2+T1+T2+T1=25 ms and the time of the second pedometer (ID code 10) is equal to T1+T2+T1+T2+T1=25 ms. The probability of two signals cross talking under worst condition will be (25 ms+25 ms)/1000 ms=0.5%.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An omnidirectional wireless pedometer, comprising:
a transmitter, which comprises a vibration sensor for detecting a vibration signal when a user walks or jogs, a transmitter control circuit, an oscillating circuit for generating an oscillating signal, a transmitting antenna, in which the vibration sensor transmits the vibration signal to the transmitter control circuit and the oscillating circuit, and the oscillating circuit generates and forwards an oscillating signal to the transmitting antenna which transmits a pace signal out wirelessly; and
a receiver, comprising three receiving antennas which are arranged in different axes for receiving wireless signals from different directions and generating resonance which is forwarded receiver control circuit for processing and generating a data signal.

2. The omnidirectional wireless pedometer as claimed in claim 1, wherein each the receiving anternnas is connected with a capacitor and forms a resonance circuit, and the three resonance circuits are connected in series.

3. The omnidirectional wireless pedometer as claimed in claim 1, wherein the receiving antennas are respectively arranged in X, Y and Z direction.

4. The omnidirectional wireless pedometer as claimed in claim 1, wherein an encoding technique is used when the transmitting antenna of the transmitter transmits the pace signal wirelessly, in which the time required for the signal to traverse one complete cycle is used, and the signal may comprises high level signal or low level signal.

5. The omnidirectional wireless pedometer as claimed in claim 4, wherein the encoding technique further comprises assigning an ID code to the transmitter for recognition.

6. The omnidirectional wireless pedometer as claimed in claim 4, wherein each pedometer is assigned with an ID code, and the transmitting antenna delays the transmission of pace signal in accordance with a delay time of the ID code, such that the interference of signal is avoided.
